(19) United States
(12) Patent Application Publication
(10) Pub. No.: US 2024/0135456 A1
(43) Pub. Date: Apr. 25, 2024

(54) PERSONAL FINANCIAL MANAGEMENT AND COACHING TOOL

(71) Applicant: Ahora Inc., Danvers, MA (US)

(72) Inventor: Samanda MORALES, Lynnfield, MA (US)

(21) Appl. No.: 18/094,042

(22) Filed: Jan. 6, 2023

Related U.S. Application Data
(60) Provisional application No. 63/297,522, filed on Jan. 7, 2022.

(51) Int. Cl. G06Q 40/06; G06Q 40/02; G06Q 40/03

(52) U.S. Cl. CPC G06Q 40/06; G06Q 40/02; G06Q 40/03

(57) ABSTRACT

A financial tool is disclosed that can be used by individuals with little or no financial knowledge to understand, manage, and plan out their personal finances. In some cases, the financial tool can present a graphical user interface (GUI) that presents certain combinations of important information to the user, allowing even an unskilled user to quickly understand their current and/or future financial position. The tool can generate and present various financial health scores (e.g., ratios) that can be easily understood by even unskilled users, such as financial health scores related to the user's emergency fund, credit score, solvency, and the like. The tool can also enable a financial coach to engage the user and assist with understanding, managing, and/or planning of the user's personal finances.

### CROSS-REFERENCE TO RELATED APPLICATIONS

This application claims priority from and benefit of U.S. Provisional Application No. 63/297,522, entitled “Personal Financial Management and Coaching Tool,” and filed on Jan. 7, 2021. The contents of that application are hereby incorporated by reference in their entirety.

### TECHNICAL FIELD

The present disclosure relates to financial tools generally and more specifically to financial tools and user interfaces for personal financial management and coaching.

### BACKGROUND

Existing budgeting or personal financial management tools are not designed to serve individuals and families with little or no financial knowledge. Some budgeting tools and wealth management services are out of reach for most working-class people, and do not engage individuals unless they already have significant assets. For example, according to www.debt.org, some tools and wealth management services require individuals have at least $75,000 in cash to invest, or at least $200,000 in assets, before the individual can make use of those tools or services. Other budgeting tools are cumbersome, complex, and inadequate for individuals who are not financially savvy and typically only focus on banking aspects, such as checking, savings, and credit card solutions. As a result, to have a full understanding of their finances and to truly plan for the future, individuals may be required to make use of numerous disparate planning tools and platforms.

Further, there are no existing personal financial management tools that integrate personal budgeting, banking, credit scores, and long term debt solutions into one digital application. Moreover, existing budgeting, or money management tools are not designed to serve socially and economically disadvantaged individuals and families.

Accordingly, it is desirable to have a personal financial management tool that integrates personal finance, budgeting, wealth building services, and banking tools that enable socially and economically disadvantaged individuals and families to manage their money and break the cycle of poverty.

### SUMMARY

The term embodiment and like terms are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, supplemented by this summary. This summary is a high-level overview of various aspects of the disclosure and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this disclosure, any or all drawings and each claim.

Embodiments of the present disclosure include a method comprising receiving financial data associated with a user. The method further comprises updating budget information based at least in part on the received financial data. The method further comprises. Determining a state of personal finance of the user based at least in part on the received financial data. The method further comprises facilitating presentation of the state of personal finance in association with the updated budget information via a graphical user interface (GUI). The method further comprises receiving goal information associated with the user, the goal information indicative of one or more financial goals of the user. The method further comprises determining progress of the one or more financial goals based at least in part on the state of personal finance. The method further comprises facilitating presentation of a notification based at least in part on the progress of the one or more financial goals via the GUI.

Embodiments of the present disclosure include a system, comprising one or more data processors; and a non-transitory computer-readable storage medium containing instructions which, when executed on the one or more data processors, cause the one or more data processors to perform the method described above.

Embodiments of the present disclosure include a computer-program product tangibly embodied in a non-transitory machine-readable storage medium, including instructions configured to cause a data processing apparatus to perform the method described above.

### BRIEF DESCRIPTION OF THE DRAWINGS

The specification makes reference to the following appended figures, in which use of like reference numerals in different figures is intended to illustrate like or analogous components.

FIG. 1. is a schematic diagram of a computing environment according to certain aspects of the present disclosure.

FIG. 2 is a schematic diagram of a financial tool according to certain aspects of the present disclosure.

FIG. 3 is a representation of a graphical user interface depicting a budget dashboard according to certain aspects of the present disclosure.

FIG. 4 is a representation of a graphical user interface depicting a personal financial health indicator dashboard according to certain aspects of the present disclosure.

FIG. 5 is a representation of a graphical user interface depicting an alternate budget dashboard according to certain aspects of the present disclosure.

FIG. 6 is a representation of a graphical user interface depicting a cash flow analysis according to certain aspects of the present disclosure.

FIG. 7 is a representation of a graphical user interface depicting a budget worksheet according to certain aspects of the present disclosure.

FIG. 8 is a representation of a graphical user interface depicting a savings and debt summary according to certain aspects of the present disclosure.

FIG. 9 is a representation of a graphical user interface depicting a loan summary according to certain aspects of the present disclosure.

FIG. 10 is a representation of a graphical user interface depicting a debt repayment plan according to certain aspects of the present disclosure.

FIG. 11 is a representation of a graphical user interface depicting a savings plan according to certain aspects of the present disclosure.

FIG. 12 is a representation of a graphical user interface depicting a bill tracker according to certain aspects of the present disclosure.

FIG. 13 is a representation of a graphical user interface depicting a budget worksheet showing essential and non-essential expenses according to certain aspects of the present disclosure.

FIG. 14 is a representation of a graphical user interface depicting a budget worksheet showing expense allocation according to certain aspects of the present disclosure.

FIG. 15 is a representation of a graphical user interface depicting an investment plan according to certain aspects of the present disclosure.

FIG. 16 is a block diagram of an example system architecture for implementing features and processes of the present disclosure

### DETAILED DESCRIPTION

Certain aspects and features of the present disclosure relate to a financial tool that can be used by individuals with little or no financial knowledge to understand, manage, and plan out their personal finances. In some cases, the financial tool can present a graphical user interface (GUI) that presents certain combinations of important information to the user, allowing even an unskilled user to quickly understand their current and/or future financial position. The tool can generate and present various financial health scores (e.g., ratios) that can be easily understood by even unskilled users, such as financial health scores related to the user's emergency fund, credit score, solvency, and the like. The tool can also enable a financial coach to engage the user and assist with understanding, managing, and/or planning of the user's personal finances.

Embodiments of the disclosure are directed to an easy-to-use online financial tool for personal financial management and coaching. The financial tool integrates personal budgeting, banking, credit scores, and long term debt solutions into one digital application that can be accessed on demand via a computing device (e.g., a smartphone or personal computer). The financial tool supports each user's financial journey and visually guides the user with real-time, personalized data. In some embodiments, the financial tool establishes a customizable bi-weekly or per-paycheck budget for the user. The financial tool empowers and teaches the users to understand their finances, manage their money, and acquire the knowledge to adeptly maximize the financial resources available to them. In some embodiments, the financial tool integrates with various banking and investment tools, such as those of financial institutions.

In some embodiments, the financial tool further integrates a financial coaching function, which enables users to smartly conquer day-to-day financial issues, such as cash crunches, financial emergencies, credit card debt, renting versus buying a home, investing, planning for retirement, saving for college, banking, and managing credit cards. The financial coaching function can work closely with users and their families to understand their financial behaviors, needs, and long-term goals. After a comprehensive review, users can receive a detailed, personalized plan tailored for their financial situation with actionable steps and measurable goals. In some embodiments, the financial coaching function is accessible via an avatar or an online chat box.

The financial data of the user may be obtained from various institutions, banks, trusts, savings and loan, businesses, companies, organizations, and creditors, among others. These entities may, for example, be servers and/or branch terminals of financial institutions, banks, savings and loans, mortgage brokers, creditors, financial service providers or other institutions, among others. The financial data may be transferred, downloaded, retrieved, requested, exchanged, or sent through an interconnected network.

Certain aspects and features of the present disclosure enable unskilled users to easily and quickly manage and understand their finances. The collection of information provided to users on various GUI dashboards can improve the efficiency with which the user interacts with the finance tool, such as by including certain combinations of information together in a single dashboard. Further, the finance tool enables users to easily be assisted by coaches in ways that help the user better understand how different decisions and suggestions made by coaches effect the user's finances. Further, the finance tool provides numerous pathways for motivating users to engage in and improve their personal finances, which can be especially useful in assisting unskilled users or users with little to no assets, who may otherwise lose interest in managing their personal finances.

Advantageously, the financial tool makes it easier for individuals and families to improve their finances and build wealth. Additionally, the financial tool offers an easy-to-use solution for employers that they can offer to employees as part of their Employee Assistance Program suite of services and benefits.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative embodiments but, like the illustrative embodiments, should not be used to limit the present disclosure. The elements included in the illustrations herein may not be drawn to scale.

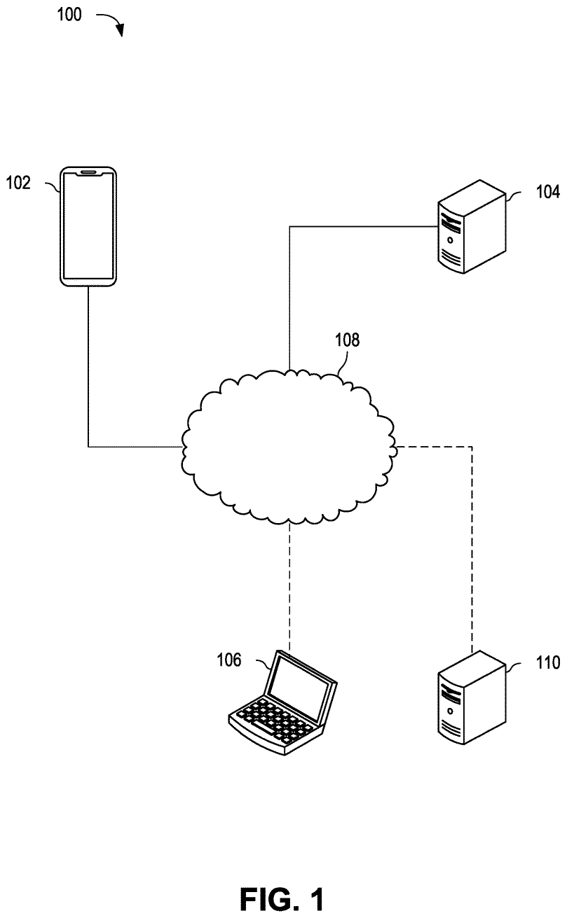

FIG. 1. is a schematic diagram of a computing environment 100 according to certain aspects of the present disclosure. The computing environment 100 can include multiple computing devices, such as a user device 102, a server 104, and optionally a coach device 106 and/or an institution device 110. User device 102 can be a smartphone, although that need not always be the case. In some cases, user device 102 can be a personal computer, a smartwatch, a tablet, or any other suitable computing device. Server 104 and institution device 110 can each be embodied in one or more computing devices. Coach device 106 can be any suitable computing device, such as a laptop computer, a smartphone, a desktop computer, or the like. The user device 102 and server 104 can be communicatively coupled via a network 108. Network 108 can be a local area network or a wide area network. Network 108 can be a cloud network or the Internet. In some cases, when a coach device 106 is used, coach device 106 is communicatively coupled to the server 104 and/or the user device 102 via the network 108. In some cases, when an institution device 110 is used, the institution device 110 is communicatively coupled to the server 104 and/or the user device 102 via the network 108.

User device 102 is any computing device used by a user to access the financial tool. In some cases, a user can switch between multiple user devices to access the financial tool, such as using a personal computer at home, using a smartphone while mobile, and using a public computer at a public location.

Sever 104 is any computing device used to serve or otherwise provide access to, or provide functionality of, various aspects of the financial tool disclosed herein.

Institution device 110 is any computing device used to serve or otherwise provide access to financial data associated with an account of the user at a particular financial institution. Any number of institution devices 110 can be used to provide access to financial data from any number of financial institutions. A financial institution can include a bank, a credit card company, an investment firm, a company providing a consumer account having monetary value, or the like.

Coach device 106 is any computing device used by a coach to access the financial tool for the purpose of providing coaching advice to a user (e.g., user of user device 102). A coach is an individual who has access to provide coaching device to a user. For example, a coach may have access to some (e.g., just financial health scores or ratios) or all of the user's financial data and can interact with the user via the financial tool (e.g., via a chat box, a screen sharing session, messages, suggested tasks, suggested goals, suggested challenges, or the like). In some cases, a single coach can switch between multiple coach devices to access the financial tool. In some cases, an individual acting as a coach for a first user may use the same device to access the financial tool for their own purposes (e.g., where that individual is a user).

Various aspects of the present disclosure can be performed on the user device 102, the server 104, the coach device 106, the institution device 110, or any combination thereof. For example, the server 104 can serve a website embodying a financial tool as disclosed herein, which can be accessed by user device 102 such that the GUI of the financial tool is presented on a display of the user device 102. Information (e.g., updated income and expense information) provided by a user via user device 102 can be transmitted to the sever 104, which can then store and/or process the information to generate further information (e.g., updated savings goals or financial health scores) to be transmitted back to the user device 102.

While computing environment 100 is described with certain computing devices, in some cases other computing devices could be used. For example, in some cases an additional individual can access the server 104 via a respective computing device to receive accountability information associated with the user, as disclosed in further detail herein.

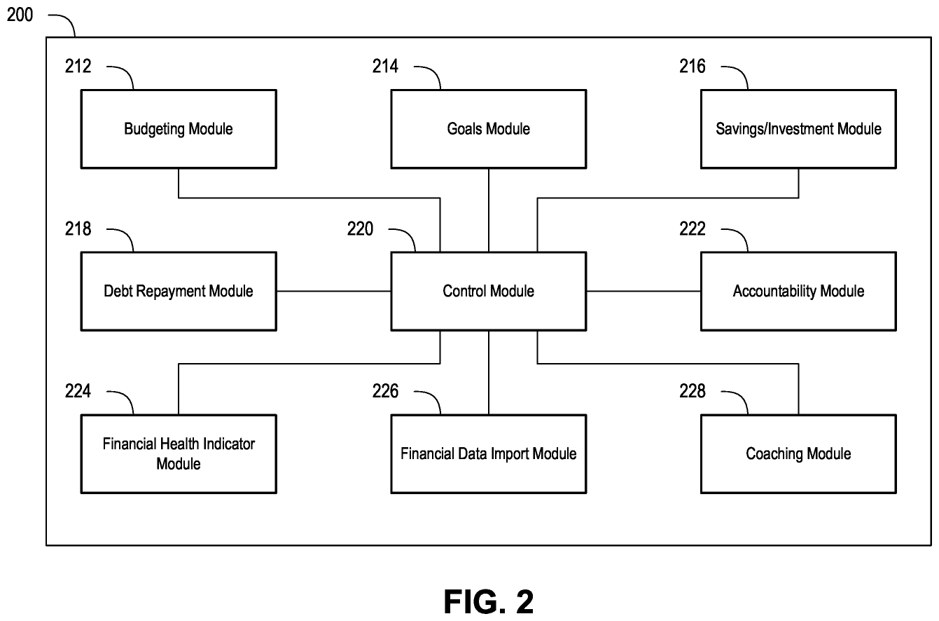

FIG. 2 is a schematic diagram of a financial tool 200 according to certain aspects of the present disclosure. The financial tool 200 can include a number of modules, each of which can facilitate performing certain functions of the financial tool 200 as disclosed herein.

A control module 220 can perform overall control of the financial tool 200 and handle user input and various outputs, such as outputting of a GUI. As used herein, outputting a GUI can include transmitting data usable to generate a GUI on a display device of a user device or other computing device (e.g., coaching device). In some cases, control module 220 can generate GUI output based on information or GUI components output by other modules of the financial tool 200. The control module 220 can facilitate presentation of notifications (e.g., a notification associated with status of or completion of a goal) to a user, a coach, or an accountability partner. Facilitating presentation of a notification can include transmitting data that, when received by a computing device (e.g., a user device) results in the notification being presented via an output device (e.g., a visual notification presented on a display, an auditory notification presented by a speaker, a haptic notification presented by a haptic motor, or the like). In some cases, presenting a notification can include presenting the notification as component of a GUI (e.g., as text in the GUI). In some cases, however, presenting a notification can occur separate from the GUI (e.g., as a text message sent to a smartphone or an email sent to an email account).

Budgeting module 212 can manage the creation of and presentation of a user budget and related information. Financial data provided to the financial tool 200 (e.g., via direct user input or via automatic import from external databases) can be manually or automatically entered into a worksheet. In some cases, the worksheet can be a cash flow analysis worksheet that permits a user to input periodic incomes, expenses, (e.g., essential expenses and non-essential expenses), assets, liabilities (e.g., loans and other debts), and optionally a credit score. Other relevant information can be included as well. The periodic values can be based on any suitable period, such as a month (e.g., monthly incomes and monthly expenses). In some cases, the cash flow worksheet can be used to automatically or manually generate a budget worksheet.

In some cases, financial data can be used to automatically or manually generate a budget worksheet in the budgeting module 212. A budget worksheet can include budgets, and optionally actual amounts, for various financial categories, such as income, expenses (e.g., fixed expenses and non-fixed expenses), debt payment, and savings. These amounts can be periodic (e.g., monthly). For example, budgeting module 212 can automatically use income information, bill-related expenses, and liability information, such as collected in the cash flow analysis worksheet or otherwise provided as financial data, to automatically generate budgets for monthly income, monthly fixed expenses (e.g., utility bills, mortgage/rent, auto insurance, etc.), debt repayment, and the like. In some cases, monthly non-fixed expenses (e.g., eating out, entertainment expenses, grocery expenses, etc.) can be automatically or manually entered from the financial data.

In some cases, the budgeting module 212 can make use of goal information (e.g., information about a user's financial goals, financial challenges, or the like) to generate or adjust one or more category budgets in the budget worksheet. For example, if the goal information for a user indicates that the user has a financial goal of reaching a certain amount of savings and a financial challenge of paying $100 extra for a particular loan each month, the budgeting module 212 can automatically make or suggest one or more changes to individual category budgets in the budget worksheet to increase the amount of budgeted savings to a threshold value necessary to reach the desired amount of savings in the desired timeframe and to increase the amount of budgeted debt repayment for the particular loan by $100 per month. In some cases, such changes can also include reducing the budgets for other categories to compensate for the increased savings and debt repayment, such as by reducing the budgets for certain non-fixed expenses like eating out or entertainment.

Budgeting module 212 can generate budget summary information, such as a total amounts of various groupings of budgets (e.g., all expenses, essential expenses, non-essential expenses, income, savings, debt payment) and net values (e.g., total income less expenses, savings, and debt repayment amounts). This budget summary information can include summary information for the budgeted amounts and/or summary information for actual amounts (e.g., actual amounts from the current time period, previous time period, or average of a number of previous time periods). For example, budget summary information generated by the budgeting module 212 can show that the user budgeted $1,065 for all their essential expenses in a current time period and has actually currently spent $553.98 for these budgeted essential expenses in the current time period.

In some cases, budgeting module 212 can make use of input from a coach to generate and/or update budget information. In an example, a user supported by a coach may initially provide financial data (e.g., manually or via automatic import) to the budgeting module 212 to generate a cash flow worksheet. The budgeting module 212 may then be used to permit access to the cash flow worksheet by the coach. The coach can then use the information from the cash flow worksheet to create a budget worksheet via the budgeting module 212, to modify a budgeting worksheet automatically generated by the budgeting module 212, or to otherwise interact with a budgeting worksheet via the budgeting module 212.

In some cases, budgeting module 212 can include an income-expense allocation feature. The income-expense allocation feature can enable a user to see and control where money from each income event (e.g., paycheck or other income event) is used. This feature can be especially useful to individuals who live paycheck-to-paycheck, users who otherwise keep low balances of liquid assets, and/or users who are paid in periods that do not align with the periods of their fixed expenses. This feature can allocate expenses (e.g., essential expenses or fixed expenses) to each income event (e.g., paycheck) based on the amount and timing of the expense and amount and timing of the income event. For example, a user may receive a paycheck every two weeks, but have several bills that must be paid on a monthly basis. The income-expense allocation feature of the budgeting module 212 can show a user which future expenses are to be paid from which paychecks. In such an example, a user may receive a first paycheck of $1000 on day 1 of a month, a second paycheck of $1000 on day 15, and a third paycheck of $1000 on day 29; the user may have a $500 bill due on day 5 and a $1000 bill due on day 19. In this example, the system can allocate the $500 bill to the first paycheck and the $1000 bill split $200-$800 between the first paycheck and the second paycheck, thus earmarking $700 of their first paycheck for payment of bills and leaving $300 for other expenses between day 1 and day 14, and earmarking $800 of their second paycheck for payment of bills and leaving $200 for other expenses between day 15 and day 28. This planning can continue for any number of periods. In some cases, allocation of expenses can be intelligently performed to ensure the user is able to meet various budgets from the budget worksheet. In some cases, other monetary events can be allocated to income events instead of or in addition to expenses, such as allocation of savings deposits to certain income events. In some cases, the user and/or coach can provide input to inform or adjust allocation of expenses or other monetary events. This feature can provide the user with an unallocated amount associated with each income event, which the user may use for discretionary spending, savings, investment, or debt repayment.

In some cases, budgeting module 212 can automatically generate reminders to make payments on certain expenses (e.g., bills), which can be presented to the user in any suitable fashion (e.g., email, text message, phone message, in-app message, push message, etc.).

Goals module 214 can facilitate the creation and monitoring of financial goals, financial challenges, and user tasks. Financial goals can include financial targets desired to be achieved by the user. Financial goals can be based on any suitable metric about the user's financial situation (e.g., a state of personal finance). Examples of states of personal finance that may be used to evaluate financial goals include i) a credit score ratio (e.g., ratio of a user's current credit score to a maximum credit score); ii) a credit score; iii) an emergency fund ratio (e.g., ratio of liquid savings to essential expenses); iv) a debt to gross income ratio (e.g., ratio of monthly debt payments to monthly income); v) a solvency ratio (e.g., a ratio of assets or liquidatable assets to liabilities); vi) a periodic savings percentage (e.g., percentage of monthly income used for savings); vii) an income to debt percentage (e.g., percentage of monthly income used for debt repayment); viii) an essential expenses percentage (e.g., percentage of monthly income used for payment of essential expenses); ix) a non-essential expenses percentage (e.g., percentage of monthly income used for payment of non-essential expenses); and x) any combination of i-ix. For example, a user desiring to build an emergency fund may have a financial goal to achieve an emergency fund ratio of at least three. In another example, a user may desire to save a set amount of money (e.g., $150) within a certain period of time (e.g., two months), in which case the financial goal may be evaluated against a total amount of savings or an amount of savings associated with a particular account.

In an example case, a financial goal may be a present plan for use of funds in addition to a fiscal plan for retirement and the anticipation of supporting a child through college. In another example case, the financial goal may be an asset allocation for a retiree in addition to a present plan encompassing receiving social security benefits and a use of funds allocations.

Financial challenges are actions that are challenging to a user and/or that a user is being challenged to complete. For example, a user may have difficulty controlling how much they spend each month on eating out. In such a case, the user may establish a financial challenge associated with eating out, which may include eating out only a set number of times per month, limiting an amount of money spent on eating out, reducing an amount of money spent on eating out as compared to a previous period (e.g., spending less on eating out this month than the last month irrespective of whether or not the amount is within a budgeted amount), and the like.

User tasks can include any other actions that a user should take or accomplish in the future. A user may set of tasks to perform actions such as setting up automatic importing of financial data, setting up a meeting with a coach, providing financial data manually, manually editing cash flow worksheets or budget worksheets, or the like.

Goals module 214 can monitor financial goals, financial challenges, and/or user tasks for completion. Goals module 214 can access information from other modules (e.g., budget summary information from budget module 212 or financial health indicators from financial health indicator module 224) to use in the evaluation of a goal, challenge, or task. When a goal is accomplished, a challenge is completed, and/or a task is completed, one or more notifications can be generated for presentation to the user, and optionally a coach and/or an accountability partner. In some cases, goal module 214 can take additional actions in response to completion of a goal, challenge, or task. For example, goal module 214 can permit access to additional features of the financial tool 200 upon detecting that a particular goal, challenge, or task has been completed. In some cases, goal module 214 can generate reminders or status updates for a goal, challenge, or task, which can be presented to a user, coach, and/or accountability partner.

In some cases, goals module 214 can calculated an expected goal completion time based on financial trends found in the user's financial data or information from other modules (e.g., budget module 212). For example, for a goal to establish an emergency fund of a particular size, the goal module 214 can calculate an expected goal completion time based on the user's current total savings amount and the user's periodic savings. For example, a user wishing to establish a particular emergency fund may receive a notification (e.g., display on the GUI) indicating that at the currently budgeted savings rate, the user will achieve the emergency fund in 6 months, but at the current actual savings rate, the user will achieve the emergency fund in 10 months. Such notifications can encourage the user to increase their savings to meet their budgeted amount. In some cases, such notifications can include suggestions for how to accomplish the goal, which can be determined by the goal module 214. In the previous example, the notification may include a recommendation to reduce the amount spent on entertainment by a certain amount and instead divert that money towards savings.

Savings/investment module 216 can monitor and present information about the user's savings and investments. Savings/investment module 216 can access information from other modules (e.g., budget module 212). In some cases, savings/investment module 216 can present information about how much the user has already saved, the rate of the user's actual saving, the rate of the user's budgeted savings, and amounts the user will have saved in the future. For example, the savings/investment module 216 can generate a display showing periodic (e.g., monthly) contributions to savings, showing that the user currently has $100 saved, but after 9 months of savings, the user will have $901.80 saved. In some cases, this display can highlight or otherwise call attention to a future period (e.g., future month) in which the user will have accomplished a goal (e.g., achieved an emergency savings fund ratio of at least 3). In some cases, future values for total savings can be based on an interest rate (e.g., a preset rate, a user-provided or coach-provided rate, or an expected rate based on historical rates).

In some cases, savings/investment module 216 can present information about the user's investments. The information can include actual investment information (e.g., current status and past performance) and/or future predicted returns. Future predicted returns can be based on an periodic deposit, which can be obtained from the budget module 212, a potential rate of return (e.g., a preset rate, a user-provided or coach-provided rate, or an expected rate based on historical performance), and an amount of time.

Debt repayment module 218 can monitor and present information about debts and other liabilities. Debt repayment module 218 can access information from other modules (e.g., budget module 212). In some cases, debt repayment module 218 can present information about the user's current debts, the rate of the user's actual debt repayment, the rate of the user's budgeted debt repayment, and amounts of debt the user will have in the future. For example, the debt repayment module 218 can generate a display showing periodic (e.g., monthly) repayments of one or more debts (e.g., loans, revolving credit accounts, and the like). saved. In some cases, this display can highlight or otherwise call attention to a future period (e.g., future month) in which the user will have accomplished a goal (e.g., fully paid off or partially paid of a particular debt). For example, a user with a mortgage, and auto loan, and a small credit card balance may have a relatively large total debt that will be paid off over the next 20-30 years, however the display may show that the user will pay off the credit card balance in the next two months, and the auto loan in the next 16 months.

In some cases, the debt repayment module 218 can generate a display showing a summary of debts, including current balances, current interest rates, current minimum payment amounts, current payment amounts (e.g., minimum payment amount plus currently planned extra payment amounts), current payoff timing, total interest paid to date, and total interest paid until the debt is paid off.

In some cases, the debt repayment module 218 can include an accelerated repayment feature, which can be used to visualize and plan accelerated repayment of a debt. In some cases, the accelerated repayment feature can depict a payoff timing based on a set amount of extra periodic payments. Based on the extra periodic payments, the system can display an accelerated payoff timing, a total interest paid until the accelerated payoff, and a difference between the total interest paid throughout the life of the debt with and without the extra periodic payments. In some cases, the accelerated repayment feature can calculate an amount of extra periodic payments based on a desired payoff timing, a desired total interest paid until the accelerated payoff, or a desired difference between the total interest paid throughout the life of the debt with and without the extra periodic payments. For example, a user wishing to payoff a particular loan in 6 months instead of 12 months can provide the desired payoff timing to the debt repayment module 218, which can then calculate and present an amount of extra periodic payments required to achieve this desired payoff timing.

In some cases, the debt repayment module 218 can receive a total amount of funds available for extra periodic payments (e.g., directly from the user or coach, or from another module, such as budget module 212) and can allocate the extra funds to multiple debts. The system can intelligently allocate the extra funds based on the user's goals, challenges, and/or user tasks; to minimize interest paid; and/or to maximize positive impact on the user's credit score. For example, a user desiring to pay off Loan A within 10 months may have $200 of extra funds available for debt repayment each month. The system can calculate that only $130 is necessary to pay off Loan A within 10 months, and may thus allocate $130 to Loan A and the remaining $70 to Loan B, which may have a high interest rate and/or significant impact on the user's credit score.

In some cases, debt repayment module 218 can automatically generate reminders to make debt repayments, which can be presented to the user in any suitable fashion (e.g., email, text message, phone message, in-app message, push message, etc.).

Accountability module 222 can control accountability functions of the finance tool 200. The accountability functions permit a user to share certain financial information with an accountability partner. The accountability partner can be an individual or entity for whom disclosure of the certain financial information would help the user remain accountable for their finances. Some examples of suitable accountability partners include a spouse, parent, friend, accountant, financial adviser, coach, or other suitable individual or entity. The user can establish one or more accountability partners through the accountability module 222, such as to set what information is shared with each accountability partner, when the information is shared, and how the accountability partner may be able to respond to shared information. Examples of information that may be shared are financial health indicators, goal statuses, challenge statuses, task statuses, budget summaries, or any other metric or financial data. In an example, the user may set up a spouse as an accountability partner that will receive a weekly update as to the user's goal progress in establishing an emergency fund. The spouse may receive weekly emails or other notifications (e.g., in-app push notifications or text message) showing the emergency fund's progress (e.g., from 0% up to 100%, from $0 up to $5000, and/or from an emergency fund ratio of 0 up to an emergency fund ratio of 3).

In some cases, a notification to an accountability partner can include an option to respond. The response can be used to provide motivation to the user or to otherwise communicate with the user about the update. For example, upon completion of a goal, the user's accountability partner may receive a notification sharing that the goal is complete and providing the accountability partner an option to send a message (e.g., “Congrats!”) or take other action (e.g., make a celebratory deposit to an account of the user) in response.

Financial health indicator module 224 can calculate and present various financial health indicators. Financial health indicators can include any metric capable of evaluating an aspect of the user's financial health (e.g., a state of personal finance of the user). In some cases, these indicators are based on data from other modules, such as budgeting module 212. Examples of financial health indicators include i) a credit score ratio (e.g., ratio of a user's current credit score to a maximum credit score); ii) a credit score; iii) an emergency fund ratio (e.g., ratio of liquid savings to essential expenses); iv) a debt to gross income ratio (e.g., ratio of monthly debt payments to monthly income); v) a solvency ratio (e.g., a ratio of assets or liquidatable assets to liabilities); vi) a periodic savings percentage (e.g., percentage of monthly income used for savings); vii) an income to debt percentage (e.g., percentage of monthly income used for debt repayment); viii) an essential expenses percentage (e.g., percentage of monthly income used for payment of essential expenses); ix) a non-essential expenses percentage (e.g., percentage of monthly income used for payment of non-essential expenses); and x) any combination of i-ix. In some cases, other metrics can be used.

Financial data import module 226 can control establishing links with and importing financial data from external data sources, such as institution devices of financial institutions. For example, financial data import module 226 can be used to establish a digital connection with a bank and automatically download and import the user's financial data associated with that bank. Such download and import can occur on demand, periodically, or automatically (e.g., in response to completion of a goal). In some cases, financial data import module 226 can be used to automatically import financial data from digital files provided by the user, such as digital files exported from other software. Data imported by the financial data import module 226 can be provided to and otherwise used in any suitable module, such as budgeting module 212 or debt repayment module 218.

Coaching module 228 can control and enable coaching features of the financial tool 200. The coaching module 228 can permit a user to grant access to certain financial information to one or more coaches. In some cases, granting access can include granting read-only or writeable access to certain aspects of the user's financial information. For example, in some cases, the coach can be granted writable access to edit a budget worksheet, but not to modify goals. In some cases, edits made by the coach can be displayed in realtime (or near realtime) on the user's GUI. For example, when working on a budget worksheet, the coach may edit a field, resulting in that field being updated in realtime (or near realtime) on the user's GUI.

The coaching module 228 can generate a dashboard that can be presented to a coach, which can include some or all of the aspects of the user's dashboard, as well as additional coaching features. In some cases, a coach dashboard can permit the addition of non-user-facing notes that are visible only to the coach, and optionally other coaches. In some cases, coaching module 228 can facilitate communication between the coach and the user, such as via messages, realtime chat, videochat, or the like.

In some cases, any module of financial tool 200 can communicate with any other module or combination of other modules in the performance of its function. While certain modules are depicted, in some cases financial tool 200 can include additional or fewer modules, as well as different modules.

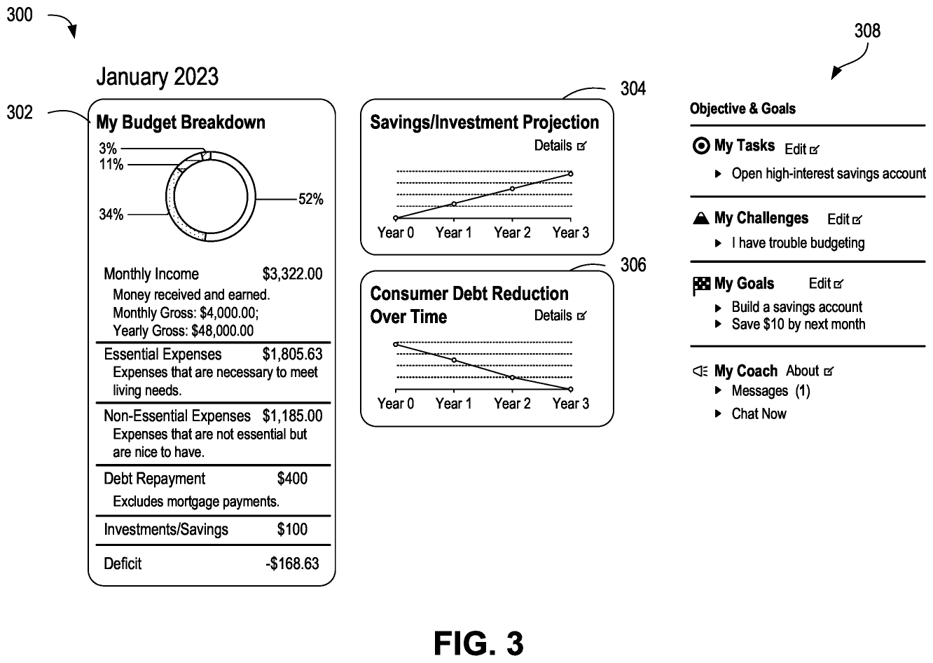

FIG. 3 is a representation of a graphical user interface 300 depicting a budget dashboard according to certain aspects of the present disclosure. The GUI 300 shows a budget dashboard containing a budget breakdown 302, a savings/investment projection 304, a consumer debt reduction over time projection 306, and a sidebar 308.

The budget breakdown 302 can include a budget summary, such as the user's periodic income (e.g., monthly income), essential expenses (e.g., expenses necessary to meet living needs), non-essential expenses (e.g., expenses that are not essential, but nice to have), debt repayment amounts, investment/savings amounts, and any surplus or deficit. The budget breakdown 302 can include a visualization (e.g., a chart, such as a pie chart), which can show the relationship of these metrics. For example, a pie chart can depict the percentage of the user's monthly income spent for essential expenses, non-essential expenses, debt repayment, and investments/savings.

The savings/investment projection 304 can include information about the user's past and/or future savings and/or investments. For example, the savings/investment projection 304 can include a visualization (e.g., a line chart) depicting the total amount of money expected to be saved at various points in time in the future based on the user's budgeted savings plan.

The consumer debt reduction over time projection 306 can include information about the user's past and/or future debts. For example, the consumer debt reduction over time projection 306 can include a visualization (e.g., a line chart) depicting the total amount of debt expected to be remaining at various points in time in the future based on the user's budgeted payoff plan.

The sidebar 308 can include various pieces of quick information useful to be displayed in association with the budget breakdown 302, savings/investment projection 304, and/or consumer debt reduction over time projection 306. For example, the sidebar 308 can include information about the user's tasks, challenges, and/or goals, as well as coaching information (e.g., messages from the coach and/or links to communicate with the coach).

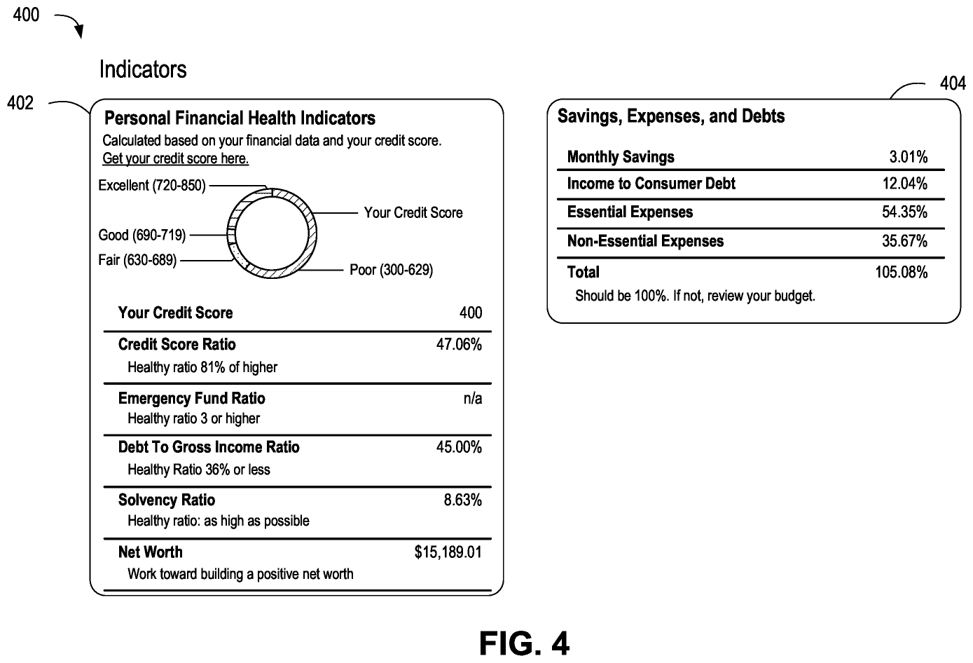

FIG. 4 is a representation of a graphical user interface 400 depicting a personal financial health indicator dashboard according to certain aspects of the present disclosure. The GUI 400 can include a personal financial health indicator summary 402 and/or a savings, expenses, and debt summary 404. In some cases, it can be useful to display both the personal financial health indicator summary 402 and savings, expenses, and debt summary 404 in a single GUI 400 to provide a simple to understand overview of the user's financial state.

The personal financial health indicator summary 402 can provide information about one or more financial health indicators, such as credit score, credit score ratio, emergency fund ratio, debt to gross income ratio, solvency ratio, and total net worth. In some cases, a visualization can be included to visualize one or more of the financial health indicators (e.g., a pie chart depicting the user's credit score in relation to possible credit scores).

The savings, expenses, and debt summary 404 can include information about how the user's income is broken down between savings, expenses, and debt. For example, the summary can show a periodic savings percentage (e.g., percentage of monthly income used for savings), an income to debt percentage (e.g., percentage of monthly income used for debt repayment), an essential expenses percentage (e.g., percentage of monthly income used for payment of essential expenses), and a non-essential expenses percentage (e.g., percentage of monthly income used for payment of non-essential expenses). In some cases, a total percentage (e.g., total percentage of the user's income spent on savings, expenses, and debt) can be provided. Generally, such a total percentage would be 100%, although a lower percentage indicates some money is unallocated and a higher percentage indicates that some category or categories are overallocated (e.g., more money is being allocated to savings, expenses, and debt than coming in from income).

In some cases (not shown), an overall financial health score can be calculated based on one or more financial health indicators. The overall financial health score can be designed to provide the user with a single, easy-to-understand score showing the overall state of the user's financial health. Each of the financial health indicators can contribute to the overall financial health score in different amounts (e.g., with different weightings).

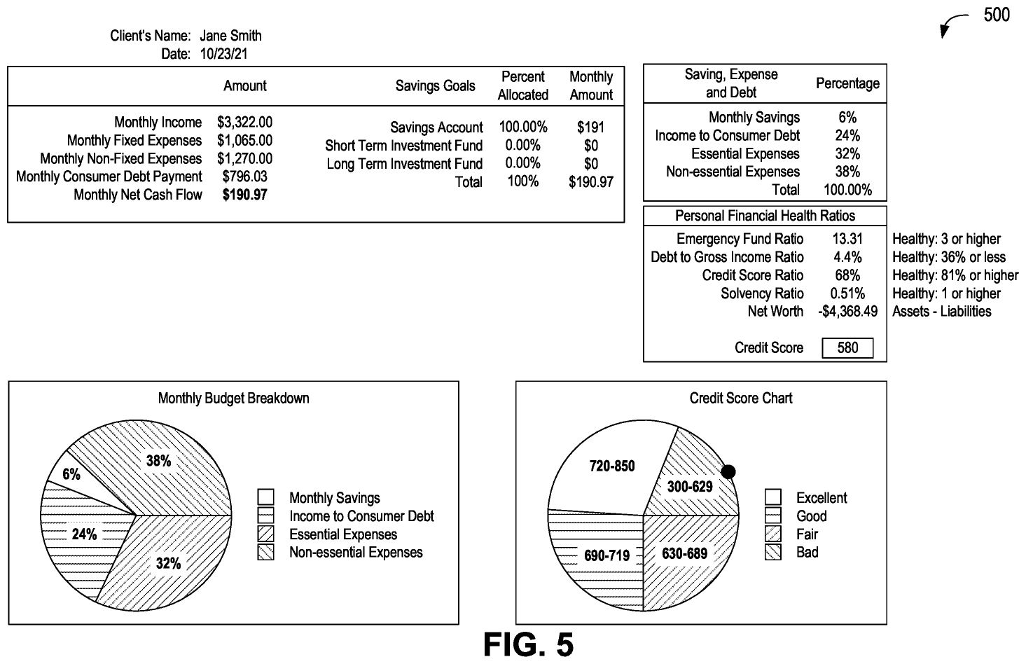

FIG. 5 is a representation of a graphical user interface 500 depicting an alternate budget dashboard according to certain aspects of the present disclosure. The dashboard can depict a user's name and the current date (e.g., date to which the information is accurate). The dashboard can include a summary showing a budget summary (e.g., amounts of monthly income, monthly fixed income, monthly non-fixed expenses, monthly consumer debt payments, and overall monthly cashflow) and a savings summary (e.g., percent and/or amount allocated to savings account(s), short-term investments, long-term investments, and total savings).

The dashboard can include a savings, expenses, and debt summary, similar to savings, expenses, and debt summary 404 of FIG. 4.

The dashboard can include a personal financial health ratios summary, which may be similar to the personal financial health indicator summary 402 of FIG. 4. In some cases, additional comments can be provided with the personal financial health ratios summary to indicate health values and/or financial goals, as well as general information about how a field is calculated.

The dashboard can include a monthly budget breakdown visualization depicting a percentage of monthly income spent on savings, debt, essential expenses, and non-essential expenses.

In some cases, the dashboard can include a credit score chart depicting the various possible credit scores, and optionally depicting where the user's credit score fits in with the various possible credit scores.

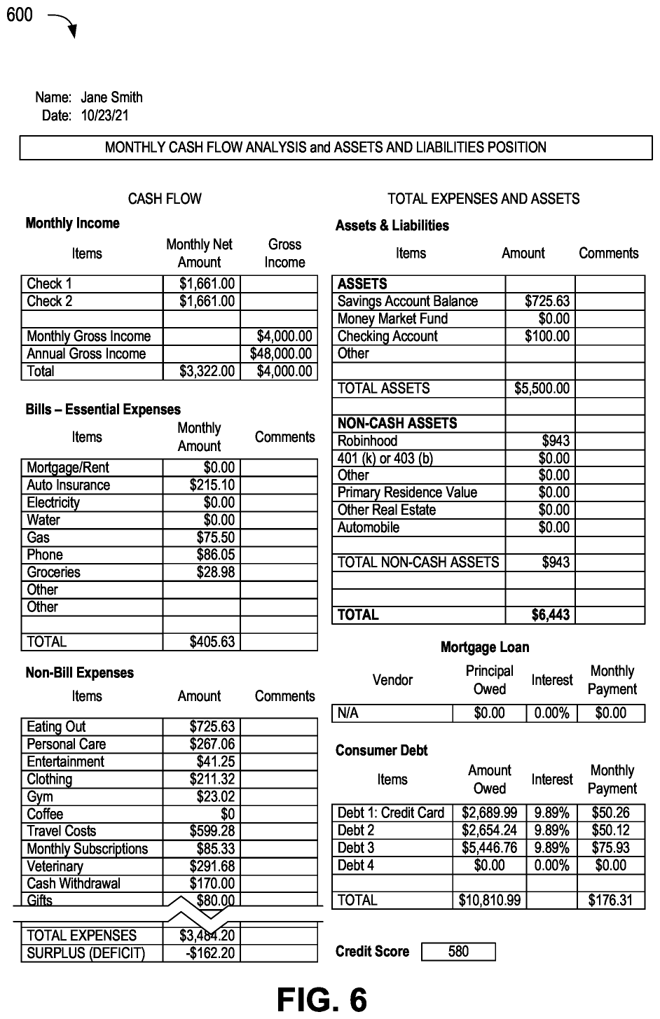

FIG. 6 is a representation of a graphical user interface 600 depicting a cash flow analysis according to certain aspects of the present disclosure. The cash flow analysis can depict a worksheet for providing and viewing cash flow information, such as monthly income, essential expenses (e.g., bills), non-essential expenses (e.g., non-bill expenses), assets, and liabilities (e.g., mortgages, loans, and other debts).

In some cases, the cash flow analysis worksheet can include the user's credit score, which may be user-provided, coach-provided, or automatically obtained through suitable channels.

In some cases, the cash flow analysis worksheet can be automatically populated with potential essential expense categories and potential non-essential expense categories, to which the user can allocate various expenses.

In some cases, the cash flow analysis worksheet can include fields for providing the amount of each category and optionally fields for providing comments for various categories.

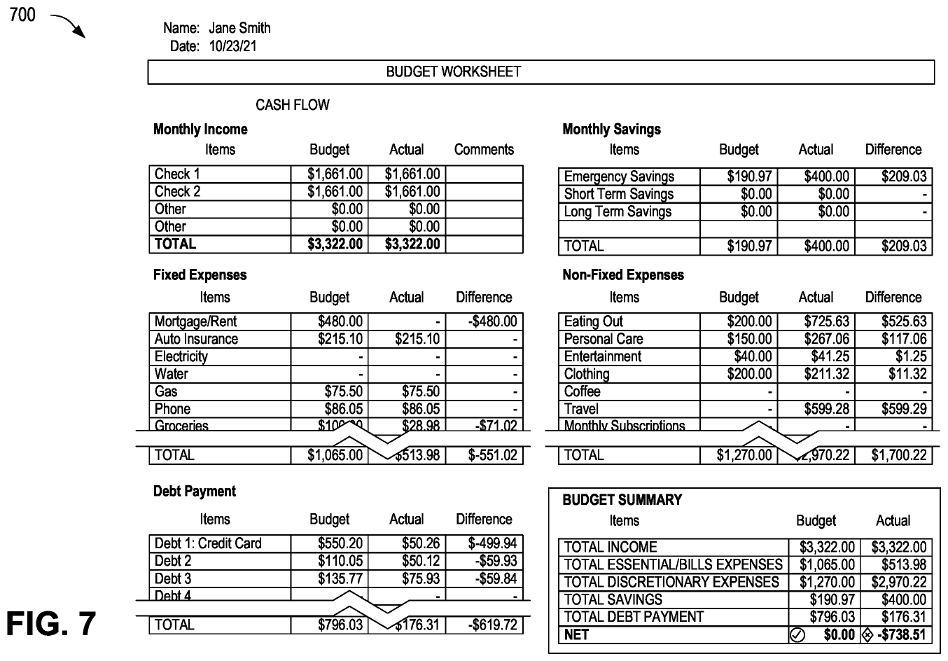

FIG. 7 is a representation of a graphical user interface 700 depicting a budget worksheet according to certain aspects of the present disclosure. The budget worksheet can include various budget information described above, such as monthly income information, fixed expenses information, debt payment information, monthly savings information, non-fixed expenses information, and a budget summary. The budget worksheet can provide fields for budgeted amounts, as well as actual amounts. The actual amounts can be manually entered or automatically determined via the financial data provided to the system. The actual amounts can be a current amount spent to date during a particular period (e.g., month), a total amount spent during a particular period (e.g., an immediately previous period), or an average amount spent per period over a number of previous periods. A difference between the budgeted amount and actual amount can be shown.

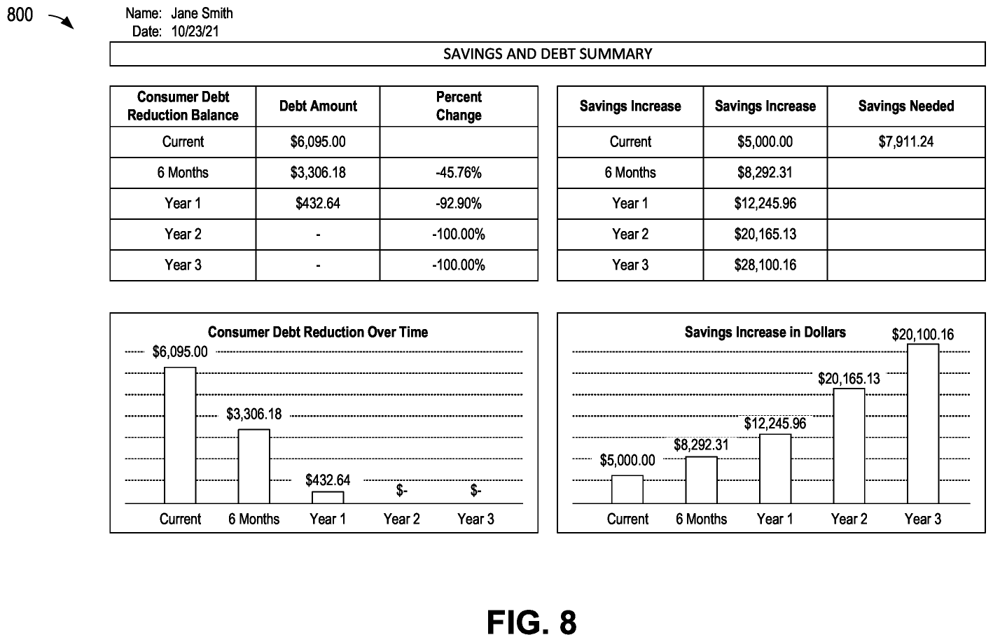

FIG. 8 is a representation of a graphical user interface 800 depicting a savings and debt summary according to certain aspects of the present disclosure. The savings and debt summary can include a listing of current debt and future debt over a period of time, and a listing of current savings and future savings over a period of time. As depicted in FIG. 8, the period of time is over three years, initially at 6 month intervals up to year one, then at yearly intervals. Other periods and intervals can be used. In some cases, a visualization (e.g., chart) can be provided for the debt and/or savings. As depicted in FIG. 8, a user currently has $6095 of debt and will pay that debt down to $3,306.18 in six months, then pay it down to $432.64 in a year, then pay it down completely before the second year. In this example, the user has a current savings of $5,000, which will accumulate to $8,292.31 by month 6, then to $12,245.96 by year one, then to $20,165.13 by year two, then to $28,100.16 by year three.

In some cases, the listing of debt and/or listing of savings can include a percent change from a previous interval (e.g., the change from the current debt to the six month debt is −45.76%). In some cases, the listing of savings can include a desired amount of savings (e.g., an amount equal to an emergency fund ratio of 3).

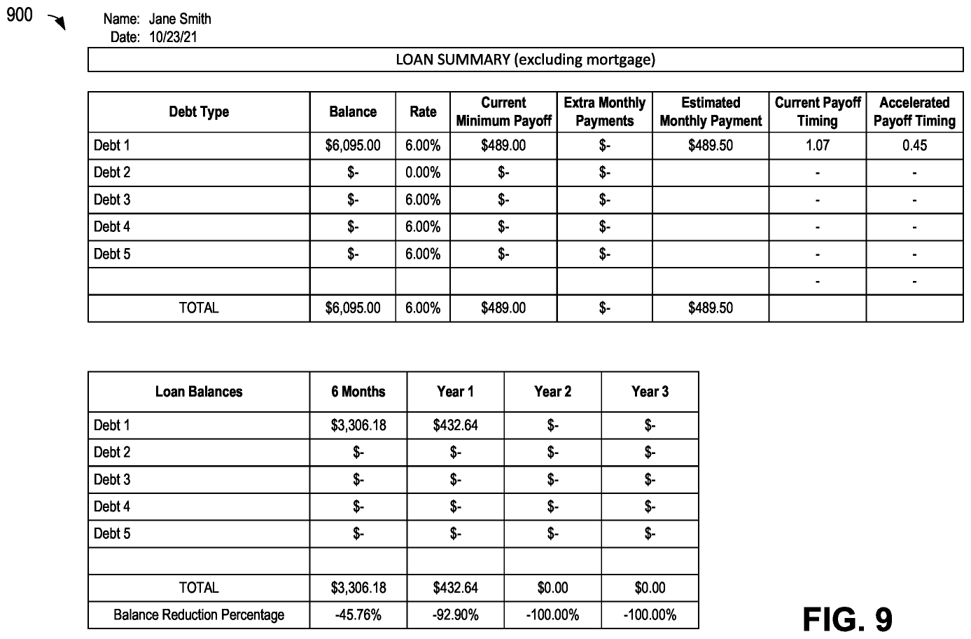

FIG. 9 is a representation of a graphical user interface 900 depicting a loan summary according to certain aspects of the present disclosure. The loan summary can include information about one or more loans or other debts of the user. The loan summary can include a loan information section containing information about the loan and its payoff plan, as well as a loan projection section showing a listing of the current debt and future debt associated with each debt over a period of time (e.g., as depicted in FIG. 9, the period of time is over three years, initially at 6 month intervals up to year one, then at yearly intervals, although other periods and intervals can be used).

The loan information section can include a debt type, a debt name, a current balance, a current rate, a current minimum required payment (e.g., monthly payment), any extra monthly payments being paid, an estimated monthly payment total (e.g., minimum required payment plus any extra monthly payment), and a current payoff timing (e.g., an indication of how long until the loan is fully paid off, such as in days, months, years, or other units). In some cases, the loan information section can further include accelerated payoff information, such as an accelerated payoff timing if certain proposed extra monthly payments are applied.

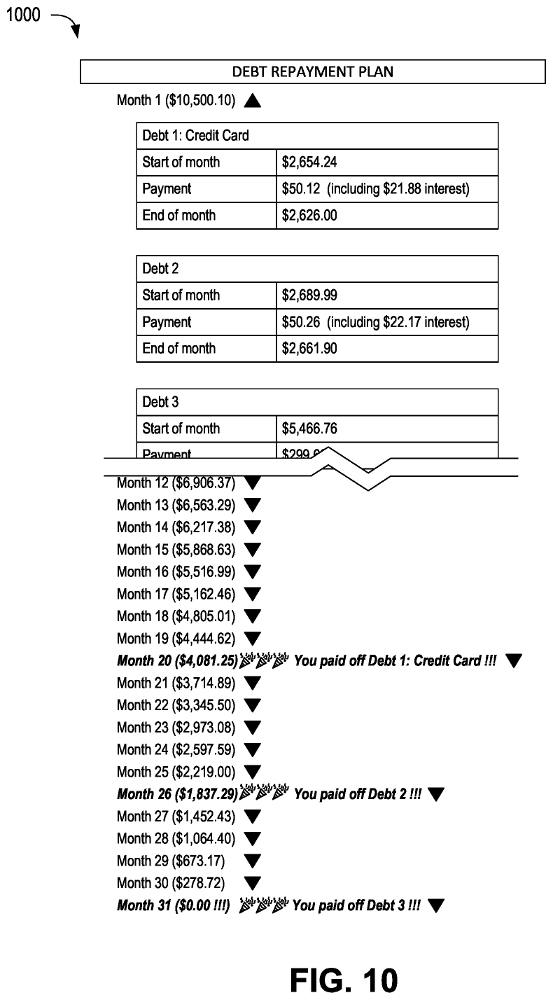

FIG. 10 is a representation of a graphical user interface 1000 depicting a debt repayment plan according to certain aspects of the present disclosure. The debt repayment plan, which can be generated by a debt repayment module (e.g., debt repayment module 218 of FIG. 2), can provide a breakdown of the user's total debt overtime (e.g., from Month 1 onwards to Month 31).

In some cases, the debt repayment plan can show the total amount of debt associated with a given time period (e.g., month). In some cases, the user can interact with (e.g., click or tap) an expand button to expand that month for a more complete overview of what debts (e.g., which loans) make up the total debt for that month, optionally including the amount of the loan at the start of the month, the amount of payment made during the month, and the amount of the loan at the end of the month.

In some cases, the debt repayment plan can highlight or otherwise call attention to months in which a debt is fully paid off or in which another goal is accomplished (e.g., a debt is paid down to 50% of its original value, or only 10% of the debt is remaining). As depicted in FIG. 10, Month 20 is highlighted and a celebratory message is displayed next to the month indicating that a particular debt has been paid off in that month. Similar messages are seen at month 26 and 31 for other debts.

In some cases, other information can be displayed along with total debt amounts, such as total amounts paid that month or percentage of total income allocated to debt repayment during that month.

In some cases, debt repayment plans can be generated on demand and/or be modified on demand to account for different payoff goals (e.g., a desired maximum monthly payment, a desired date to payoff one or more debts, a desire to minimize interest, and the like).

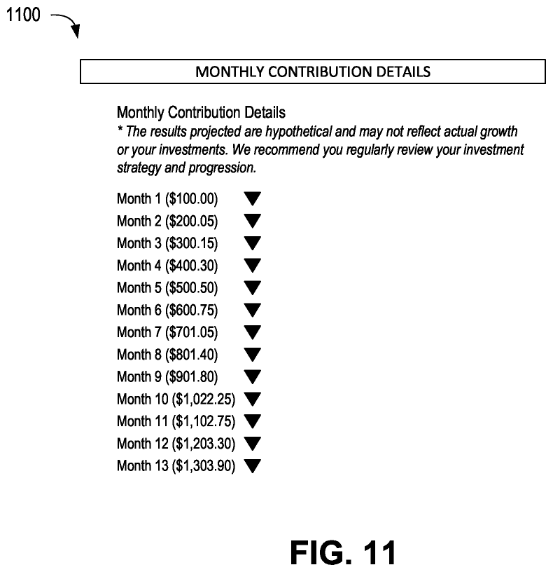

FIG. 11 is a representation of a graphical user interface 1100 depicting a savings plan according to certain aspects of the present disclosure. The savings (e.g., savings and/or investment) plan, which can be generated by a savings/investment module (e.g., savings/investment module 216 of FIG. 2), can provide a breakdown of the user's total savings over time (e.g., from Month 1 onwards to Month 13 and beyond).

Like the debt repayment plan of FIG. 10, the savings plan can show a total amount of savings associated with a given time period (e.g., month). In some cases, the user can interact with (e.g., click or tap) an expand button to expand that month for a more complete overview of what savings (e.g., which savings accounts and investments) make up the total savings for that month, optionally including the value of the savings account or investment at the start of the month, the amount of increase made during the month, the amount of increase attributable to interest or expected rate of return, and the value of the savings account or investment at the end of the month.

In some cases, the savings plan can highlight or otherwise call attention to months in which a savings goal is achieved (e.g., total savings is sufficient for the user's emergency fund ratio to be 3). For example, when a goal is achieved, that month can be highlighted and a message can be presented next to the month congratulating the user on achieving the goal.

In some cases, other information can be displayed along with total savings amounts, such as total amounts saved that month or percentage of total income allocated to savings during that month.

In some cases, savings plans can be generated on demand and/or be modified on demand to account for different savings goals (e.g., a desired maximum monthly allocation to savings, a desired date to achieve a particular goal, and the like).

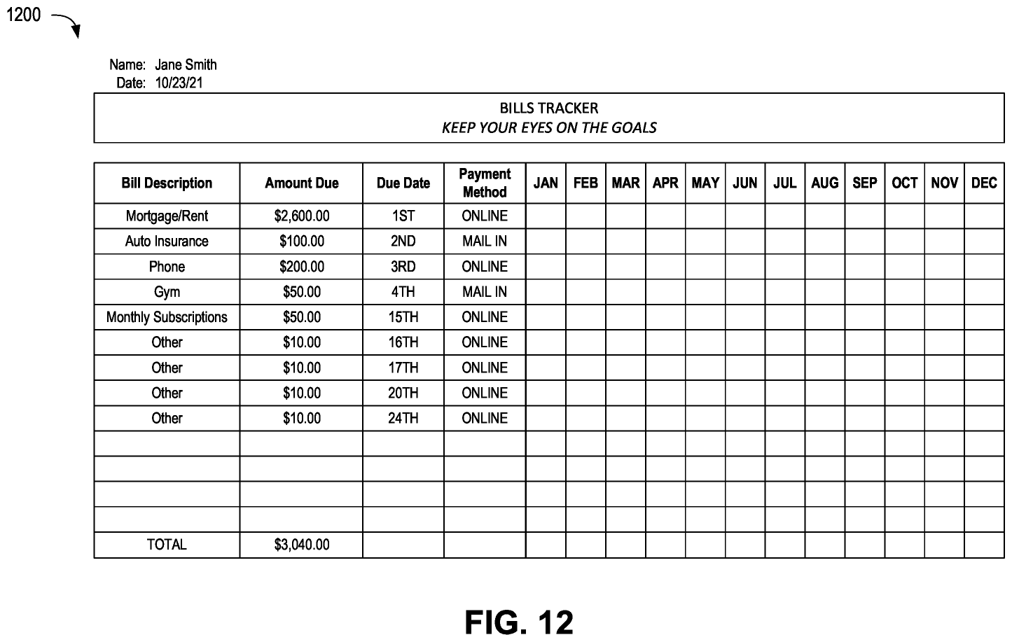

FIG. 12 is a representation of a graphical user interface 1200 depicting a bill tracker according to certain aspects of the present disclosure. The bill tracker can be used to keep track of periodic expenses (referred to herein as “bills”), such as utility bills, gym memberships, and the like. The bill tracker can provide information about the type of bill, the amount due, the due date in each period (e.g., in each month), the method of payment, and payment information for each period (e.g., each month). For example, the bill tracker can be used to record or identify that bills have been paid each month. The bill tracker can also provide a total of all bill amounts.

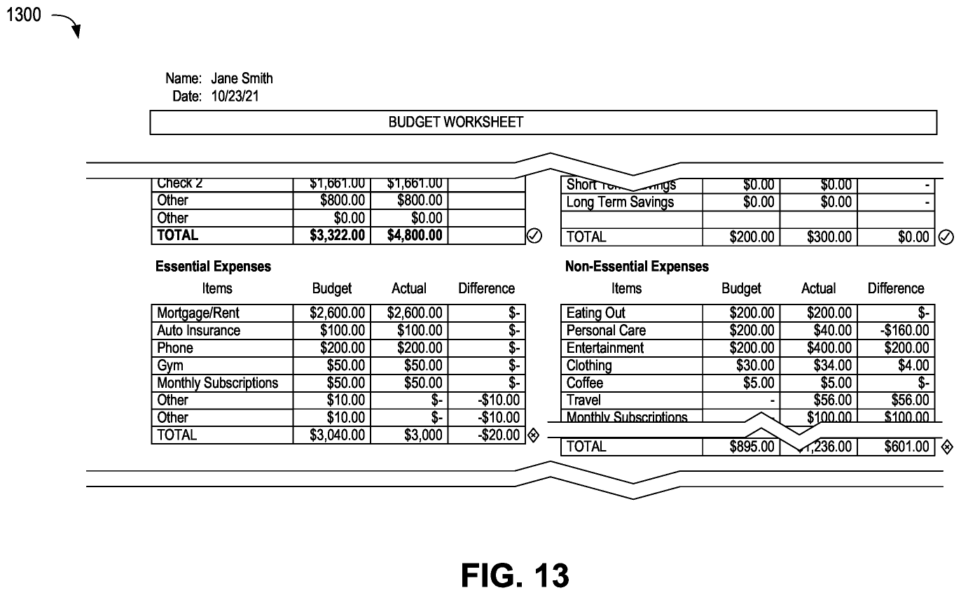

FIG. 13 is a representation of a graphical user interface 1300 depicting a budget worksheet showing essential and non-essential expenses according to certain aspects of the present disclosure. The budget worksheet can be similar to budget worksheet of FIG. 7, although instead of fixed expenses and non-fixed expenses, the expenses can be broken out into essential expenses and non-essential expenses.

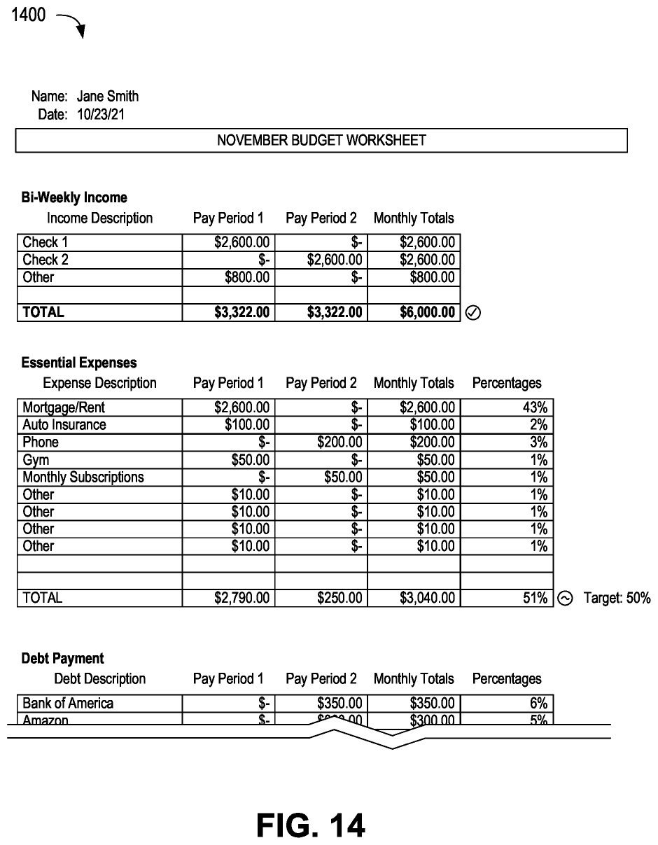

FIG. 14 is a representation of a graphical user interface 1400 depicting a budget worksheet showing expense allocation according to certain aspects of the present disclosure. Such a budget worksheet can be known as a budget payment plan. The budget worksheet can be broken out by income events (e.g., pay periods), allowing for expenses and other monetary allocations to be allocated to specific income events (e.g., paychecks) instead of allocated generally over a month of income. This type of budget worksheet permits users to have a closer understanding of when cash will be available and needed throughout the month, and what amounts of each paycheck are available for different purposes.

As depicted in FIG. 14, the user is paid in a bi-weekly manner, with two pay periods in the current month. An income section shows the various income events, allocating each income event to a given pay period (e.g., a first check allocated to pay period 1 and a second check allocated to pay period 2). An “other” income is shown as allocated to pay period 1, as it is paid to the user during that pay period.

An essential expenses section is shown, listing various expenses and their amounts. Depending on the timing of the expense and/or the amount of the expense, the expense can be allocated to either the first pay period or the second pay period. Here, the user allocates most expenses to the first pay period, except for a “Phone” expense and a “Monthly Subscriptions” expense, which are allocated to the second pay period. Totals are seen for the various pay periods, and monthly totals are seen for each expense. Also depicted are percentages of the total income attributed to that expense. For this user, the total amount of essential expenses is approximately 51% of their total monthly income. In some cases, a target number (e.g., a user-set target number, a coach-set target number, an automatically generated target number, or a preset target number) can be provided, such as a target amount of the monthly income that should be attributed to essential expenses, which is depicted here as 50%. Thus, the user can quickly see that they are in relatively good shape, although may wish to try and slightly reduce some of their essential expenses to come in under 50%.

While not depicted in full, the budget worksheet can include various other sections, such as non-essential expenses, debts, and savings/investments.

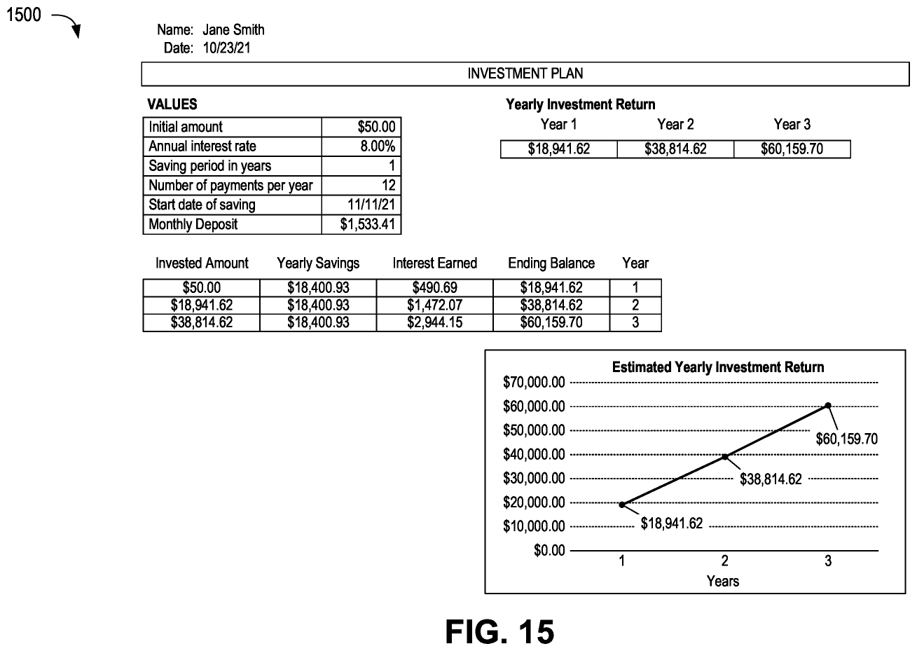

FIG. 15 is a representation of a graphical user interface 1500 depicting an investment plan according to certain aspects of the present disclosure. The investment plan can be generated by the savings/investment module (e.g., savings/investment module 216 of FIG. 2). The investment plan can include information about a potential investment strategy. A deposit amount can be provided (e.g., manually or automatically from a budget worksheet) and a start date can be set to begin periodic deposits (e.g., 12 deposits a year for monthly deposits). An initial amount can be provided, and an annual interest rate (e.g., rate of return) can be established (e.g., a user-provided rate, a coach-provided rate, a preset rate, or an expected rate based on historical performance). In some cases, a duration for saving can be set.

The investment plan can then present a summary of amount invested, total savings per period, interest earned, and ending balances for a number of periods (e.g., a number of years). In some cases, the investment plan can present the total savings per period (e.g., yearly investment return) in a textual format and/or a visualization (e.g., a chart). In some cases, the various values used to establish the investment plan can be modified on demand, such as by a user or coach.

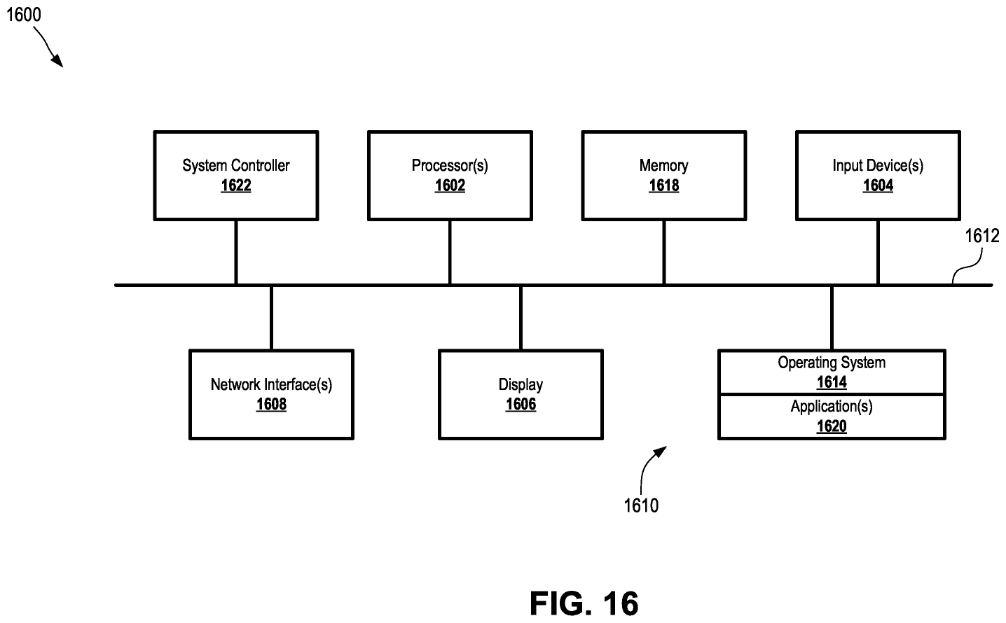

FIG. 16 is a block diagram of an example system architecture 1600 for implementing features and processes of the present disclosure, such as those presented with reference to FIGS. 1-15. The architecture 1600 can be used to implement a server (e.g., server 104 of FIG. 1), a user device (e.g., user device 102 of FIG. 1), or any other suitable device for performing some or all of the aspects of the present disclosure. The architecture 1600 can be implemented on any electronic device that runs software applications derived from compiled instructions, including without limitation personal computers, servers, smart phones, electronic tablets, game consoles, email devices, and the like. In some implementations, the architecture 1600 can include one or more processors 1602, one or more input devices 1604, one or more display devices 1606, one or more network interfaces 1608, and one or more computer-readable mediums 1610. Each of these components can be coupled by bus 1612.

Display device 1606 can be any known display technology, including but not limited to display devices using Liquid Crystal Display (LCD) or Light Emitting Diode (LED) technology. Processor(s) 1602 can use any known processor technology, including but not limited to graphics processors and multi-core processors. Input device 1604 can be any known input device technology, including but not limited to a keyboard (including a virtual keyboard), mouse, track ball, and touch-sensitive pad or display. In some cases, audio inputs can be used to provide audio signals, such as audio signals of an individual speaking. Bus 1612 can be any known internal or external bus technology, including but not limited to ISA, EISA, PCI, PCI Express, NuBus, USB, Serial ATA or FireWire.

Computer-readable medium 1610 can be any medium that participates in providing instructions to processor(s) 1602 for execution, including without limitation, non-volatile storage media (e.g., optical disks, magnetic disks, flash drives, etc.) or volatile media (e.g., SDRAM, ROM, etc.). The computer-readable medium (e.g., storage devices, mediums, and memories) can include, for example, a cable or wireless signal containing a bit stream and the like. However, when mentioned, non-transitory computer-readable storage media expressly exclude media such as energy, carrier signals, electromagnetic waves, and signals per se.

Computer-readable medium 1610 can include various instructions for implementing operating system 1614 and applications 1620 such as computer programs. The operating system can be multi-user, multiprocessing, multitasking, multithreading, real-time and the like. The operating system 1614 performs basic tasks, including but not limited to: recognizing input from input device 1604; sending output to display device 1606; keeping track of files and directories on computer-readable medium 1610; controlling peripheral devices (e.g., storage drives, interface devices, etc.) which can be controlled directly or through an I/O controller; and managing traffic on bus 1612. Computer-readable medium 1610 can include various instructions for implementing firmware processes, such as a BIOS. Computer-readable medium 1610 can include various instructions for implementing any of the processes described herein, including those described with reference to FIGS. 1-15.

Memory 1618 can include high-speed random access memory and/or non-volatile memory, such as one or more magnetic disk storage devices, one or more optical storage devices, and/or flash memory (e.g., NAND, NOR). The memory 1618 (e.g., computer-readable storage devices, mediums, and memories) can include a cable or wireless signal containing a bit stream and the like. However, when mentioned, non-transitory computer-readable storage media expressly exclude media such as energy, carrier signals, electromagnetic waves, and signals per se. The memory 1618 can store an operating system, such as Darwin, RTXC, LINUX, UNIX, OS X, WINDOWS, or an embedded operating system such as VxWorks.

System controller 1622 can be a service processor that operates independently of processor 1602. In some implementations, system controller 1622 can be a baseboard management controller (BMC). For example, a BMC is a specialized service processor that monitors the physical state of a computer, network server, or other hardware device using sensors and communicating with the system administrator through an independent connection. The BMC is configured on the motherboard or main circuit board of the device to be monitored. The sensors of a BMC can measure internal physical variables such as temperature, humidity, power-supply voltage, fan speeds, communications parameters and operating system (OS) functions.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computing system that includes a back-end component, such as a data server, or that includes a middleware component, such as an application server or an Internet server, or that includes a front-end component, such as a client computer having a graphical user interface or an Internet browser, or any combination thereof. The components of the system can be connected by any form or medium of digital data communication such as a communication network. Examples of communication networks include, e.g., a LAN, a WAN, and the computers and networks forming the Internet.

The computing system can include clients and servers. A client and server are generally remote from each other and typically interact through a network. The relationship of client and server arises by virtue of computer programs running on the respective computers and having a client-server relationship to each other.

One or more features or steps of the disclosed embodiments can be implemented using an application programming interface (API). An API can define one or more parameters that are passed between a calling application and other software code (e.g., an operating system, library routine, function) that provides a service, that provides data, or that performs an operation or a computation.

The API can be implemented as one or more calls in program code that send or receive one or more parameters through a parameter list or other structure based on a call convention defined in an API specification document. A parameter can be a constant, a key, a data structure, an object, an object class, a variable, a data type, a pointer, an array, a list, or another call. API calls and parameters can be implemented in any programming language. The programming language can define the vocabulary and calling convention that a programmer will employ to access functions supporting the API.

In some implementations, an API call can report to an application the capabilities of a device running the application, such as input capability, output capability, processing capability, power capability, communications capability, and the like.

The foregoing description of the embodiments, including illustrated embodiments, has been presented only for the purpose of illustration and description and is not intended to be exhaustive or limiting to the precise forms disclosed. Numerous modifications, adaptations, and uses thereof will be apparent to those skilled in the art. Numerous changes to the disclosed embodiments can be made in accordance with the disclosure herein, without departing from the spirit or scope of the disclosure. Thus, the breadth and scope of the present disclosure should not be limited by any of the above described embodiments.

Although certain aspects and features of the present disclosure have been illustrated and described with respect to one or more implementations, equivalent alterations and modifications will occur or be known to others skilled in the art upon the reading and understanding of this specification and the annexed drawings. In addition, while a particular feature may have been disclosed with respect to only one of several implementations, such feature may be combined with one or more other features of the other implementations as may be desired and advantageous for any given or particular application.

The terminology used herein is for the purpose of describing particular embodiments only, and is not intended to be limiting of the disclosure. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof, are used in either the detailed description and/or the claims, such terms are intended to be inclusive in a manner similar to the term “comprising.”

One or more elements or aspects or steps, or any portion(s) thereof, from one or more of any of claims 1 to 20 below can be combined with one or more elements or aspects or steps, or any portion(s) thereof, from one or more of any of the other claims 1 to 20 or combinations thereof, to form one or more additional implementations and/or claims of the present disclosure.

As used below, any reference to a series of examples is to be understood as a reference to each of those examples disjunctively (e.g., “Examples 1-4” is to be understood as “Examples 1, 2, 3, or 4”).
Example 1 is a method comprising: receiving financial data associated with a user; updating budget information based at least in part on the received financial data; determining a state of personal finance of the user based at least in part on the received financial data; facilitating presentation of the state of personal finance in association with the updated budget information via a graphical user interface (GUI); receiving goal information associated with the user, the goal information indicative of one or more financial goals of the user; determining progress of the one or more financial goals based at least in part on the state of personal finance; and facilitating presentation of a notification based at least in part on the progress of the one or more financial goals via the GUI.
Example 2 is the method of example(s) 1, wherein the financial data includes i) income information; ii) expense information; iii) debt information; iv) asset information; v) a credit score; or vi) any combination of i-v
Example 3 is the method of example(s) 1 or 2, wherein the state of personal finance includes i) a credit score ratio; ii) an emergency fund ratio; iii) a debt to gross income ratio; iv) a solvency ratio; or v) any combination of i-iv.
Example 4 is the method of example(s) 1-3, wherein the state of personal finance includes i) a periodic savings percentage; ii) an income to debt percentage; iii) an essential expenses percentage; and iv) a non-essential expenses percentage.
Example 5 is the method of example(s) 1-4, further comprising providing a preset list of potential essential expenses and potential non-essential expenses, wherein receiving the financial data of the user further includes receiving categorization information for at least a first portion of the financial data, the categorization information indicative of one or more potential essential expenses or one or more potential non-essential expenses from the preset list of potential essential expenses and potential non-essential expenses.
Example 6 is the method of example(s) 1-5, wherein facilitating presentation of the notification includes generating a celebratory message associated with the one or more financial goals when the determined progress indicates completion of the one or more financial goals.
Example 7 is the method of example(s) 1-6, further comprising: receiving a request for coaching associated with the user; providing access to the budget information to a coaching user; and facilitating communication between the user and the coaching user via the GUI.
Example 8 is the method of example(s) 7, wherein receiving the goal information associated with the user includes receiving the goal information from the coaching user.
Example 9 is the method of example(s) 8, wherein receiving the goal information associated with the user includes generating a prompt for the user to accept or reject or modify the goal information as received from the coaching user.
Example 10 is the method of example(s) 1-9, wherein the financial data includes debt information, the method further comprising: generating a debt repayment plan based on the debt information, the state of personal finance, and the goal information; facilitating presentation of the debt repayment plan via the GUI.
Example 11 is the method of example(s) 10, wherein the debt information is associated with a plurality of debts, wherein the debt repayment plan includes a total periodic payment comprising individual periodic payments for each of the plurality of debts, and wherein facilitating presentation of the debt repayment plan via the GUI results in presentation of: a current total debt value based on the plurality of debts; a series of future total debt values over the course of a plurality of periods, wherein each of the future total debt values is an indication of a future total debt after payment of a given number of periods of individual periodic payments; and a payoff indication for each of the plurality of debts in association with the respective period of the plurality of periods in which that respective debt is fully paid off.
Example 12 is the method of example(s) 1-11, wherein the financial data includes savings information, the method further comprising: generating a savings plan based on the savings information, the state of personal finance, and the goal information; facilitating presentation of the savings plan via the GUI.
Example 13 is the method of example(s) 12, wherein the goal information includes a savings goal, wherein the savings plan includes a periodic savings amount, and wherein facilitating presentation of the savings plan via the GUI results in presentation of: a current total savings amount; a series of future total savings amounts over the course of a plurality of periods, wherein each of the future total savings amounts is an indication of a future total savings after addition of the periodic savings amount for a given number of periods; and a goal completion indication in association with the respective period of the plurality of periods in which the future total savings amount meets or exceeds the savings goal.
Example 14 is the method of example(s) 1-13, further comprising: receiving selection of an accountability partner; and transmitting the determined progress to the accountability partner.
Example 15 is the method of example(s) 14, further comprising: receiving a message originating from the accountability partner in response to transmitting the determined progress; and facilitating presentation of the message via the GUI.
Example 16 is the method of example(s) 1-15, wherein the financial data includes income information and periodic expense information, wherein the income information includes an amount and a timing for a plurality of income events occurring within a set period, wherein the periodic expense information includes an amount and a due date for a plurality of expenses occurring within the set period, the method further comprising: generating an budget payment plan based at least in part on the income information and the periodic expense information, wherein generating the budget payment plan includes assigning each of the plurality of expenses to income events of the plurality of income events based on the amount and timing of the plurality of income events and the amount and timing of the plurality of expenses; and facilitating presentation of the budget payment plan via the GUI.
Example 17 is the method of example(s) 16, wherein generating the budget payment plan further includes generating a notification if a total amount of each of the plurality of expenses assigned to a given income event exceeds the amount of the given income event.
Example 18 is the method of example(s) 1-17, wherein receiving financial data associated with the user includes: establishing a digital connection with a financial institution; and receiving the financial data via the digital connection.
Example 19 is a system, comprising: one or more data processors; and a non-transitory computer-readable storage medium containing instructions which, when executed on the one or more data processors, cause the one or more data processors to perform the method of example(s) 1-18.
Example 20 is a computer-program product tangibly embodied in a non-transitory machine-readable storage medium, including instructions configured to cause a data processing apparatus to perform the method of example(s) 1-18.

What is claimed is:

1. A method comprising:
receiving financial data associated with a user;
updating budget information based at least in part on the received financial data;
determining a state of personal finance of the user based at least in part on the received financial data;
facilitating presentation of the state of personal finance in association with the updated budget information via a graphical user interface (GUI);
receiving goal information associated with the user, the goal information indicative of one or more financial goals of the user;
determining progress of the one or more financial goals based at least in part on the state of personal finance; and
facilitating presentation of a notification based at least in part on the progress of the one or more financial goals via the GUI.

2. The method of claim 1, wherein the financial data includes i) income information; ii) expense information; iii) debt information; iv) asset information; v) a credit score; or vi) any combination of i-v

3. The method of claim 1, wherein the state of personal finance includes i) a credit score ratio; ii) an emergency fund ratio; iii) a debt to gross income ratio; iv) a solvency ratio; or v) any combination of i-iv.

4. The method of claim 1, wherein the state of personal finance includes i) a periodic savings percentage; ii) an income to debt percentage; iii) an essential expenses percentage; and iv) a non-essential expenses percentage.

5. The method of claim 1, further comprising providing a preset list of potential essential expenses and potential non-essential expenses, wherein receiving the financial data of the user further includes receiving categorization information for at least a first portion of the financial data, the categorization information indicative of one or more potential essential expenses or one or more potential non-essential expenses from the preset list of potential essential expenses and potential non-essential expenses.

6. The method of claim 1, wherein facilitating presentation of the notification includes generating a celebratory message associated with the one or more financial goals when the determined progress indicates completion of the one or more financial goals.

7. The method of claim 1, further comprising:
receiving a request for coaching associated with the user;
providing access to the budget information to a coaching user; and
facilitating communication between the user and the coaching user via the GUI.

8. The method of claim 7, wherein receiving the goal information associated with the user includes receiving the goal information from the coaching user.

9. The method of claim 8, wherein receiving the goal information associated with the user includes generating a prompt for the user to accept or reject or modify the goal information as received from the coaching user.

10. The method of claim 1, wherein the financial data includes debt information, the method further comprising:
generating a debt repayment plan based on the debt information, the state of personal finance, and the goal information;
facilitating presentation of the debt repayment plan via the GUI.

11. The method of claim 10, wherein the debt information is associated with a plurality of debts, wherein the debt repayment plan includes a total periodic payment comprising individual periodic payments for each of the plurality of debts, and wherein facilitating presentation of the debt repayment plan via the GUI results in presentation of:
a current total debt value based on the plurality of debts;
a series of future total debt values over the course of a plurality of periods, wherein each of the future total debt values is an indication of a future total debt after payment of a given number of periods of individual periodic payments; and
a payoff indication for each of the plurality of debts in association with the respective period of the plurality of periods in which that respective debt is fully paid off.

12. The method of claim 1, wherein the financial data includes savings information, the method further comprising:
generating a savings plan based on the savings information, the state of personal finance, and the goal information;
facilitating presentation of the savings plan via the GUI.

13. The method of claim 12, wherein the goal information includes a savings goal, wherein the savings plan includes a periodic savings amount, and wherein facilitating presentation of the savings plan via the GUI results in presentation of:
a current total savings amount;
a series of future total savings amounts over the course of a plurality of periods, wherein each of the future total savings amounts is an indication of a future total savings after addition of the periodic savings amount for a given number of periods; and
a goal completion indication in association with the respective period of the plurality of periods in which the future total savings amount meets or exceeds the savings goal.

14. The method of claim 1, further comprising:
receiving selection of an accountability partner; and
transmitting the determined progress to the accountability partner.

15. The method of claim 14, further comprising:
receiving a message originating from the accountability partner in response to transmitting the determined progress; and
facilitating presentation of the message via the GUI.

16. The method of claim 1, wherein the financial data includes income information and periodic expense information, wherein the income information includes an amount and a timing for a plurality of income events occurring within a set period, wherein the periodic expense information includes an amount and a due date for a plurality of expenses occurring within the set period, the method further comprising:
generating a budget payment plan based at least in part on the income information and the periodic expense information, wherein generating the budget payment plan includes allocating each of the plurality of expenses to income events of the plurality of income events based on the amount and timing of the plurality of income events and the amount and timing of the plurality of expenses; and
facilitating presentation of the budget payment plan via the GUI.

17. The method of claim 16, wherein generating the budget payment plan further includes generating a notification if a total amount of each of the plurality of expenses assigned to a given income event exceeds the amount of the given income event.

18. The method of claim 1, wherein receiving financial data associated with the user includes:
establishing a digital connection with a financial institution; and
receiving the financial data via the digital connection.

19. A system, comprising:
one or more data processors; and
a non-transitory computer-readable storage medium containing instructions which, when executed on the one or more data processors, cause the one or more data processors to perform the method of claim 1.

20. A computer-program product tangibly embodied in a non-transitory machine-readable storage medium, including instructions configured to cause a data processing apparatus to perform the method of claim 1.
